(19) United States
(12) Patent Application Publication
(10) Pub. No.: US 2026/0360252 A1
(43) Pub. Date: Nov. 12, 2026

(54) SYSTEM AND METHOD FOR DETERMINING A TRAFFIC SIGNAL PHASE DURATION

(71) Applicant: GM GLOBAL TECHNOLOGY OPERATIONS LLC, Detroit, MI (US)

(72) Inventors: Vivek Vijaya Kumar, Shelby Township, MI (US); Shah Hussain, Dearborn, MI (US)

(73) Assignee: GM GLOBAL TECHNOLOGY OPERATIONS LLC, Detroit, MI (US)

(21) Appl. No.: 19/202,182

(22) Filed: May 8, 2025

(51) Int. Cl. G08G 1/01; G08G 1/07; G08G 1/096; B60W 30/18

(52) U.S. Cl. CPC G08G 1/0145; G08G 1/07; G08G 1/096; B60W 30/18154; B60W 2710/06; B60W 2720/10

(57) ABSTRACT

A method of operating a vehicle includes receiving traffic signal information from an infrastructure system for a traffic signal with the traffic signal information having a current signal phase of the traffic signal and determining a type of controller for the traffic signal based on the traffic signal information. The method also includes determining a remaining time interval for the current signal phase for the vehicle and directing an operation of the vehicle based on the remaining time interval for the current signal phase.

### BACKGROUND

The present disclosure relates to vehicle traffic management, and more particularly, to a system and method that determines a duration for a traffic signal phase in a given direction for a vehicle.

Many drivers experience delays due to traffic during their commutes or when traveling. Various types of infrastructure are implemented for managing traffic. For example, some roadways may include variable traffic lanes that change directions based on time of the day and the day of the week. Additionally, traffic signals can be timed to maintain a flow of traffic along a main roadway to reduce traffic congestion.

### SUMMARY

Disclosed herein is a method of operating a vehicle. The method includes receiving traffic signal information from an infrastructure system for a traffic signal with the traffic signal information having a current signal phase of the traffic signal and determining a type of controller for the traffic signal based on the traffic signal information. The method also includes determining a remaining time interval for the current signal phase for the vehicle and directing an operation of the vehicle based on the remaining time interval for the current signal phase.

In one aspect of the of the disclosure the method includes determining a confidence level for the remaining time interval and directing the operation of the vehicle based on the remaining time interval and the confidence level.

In one aspect of the of the disclosure the operation of the vehicle includes starting or stopping an engine on the vehicle with a start/stop system on the vehicle.

In one aspect of the of the disclosure the operation includes utilizing a red light violation warning system on the vehicle to warn an operator of the vehicle of a red signal phase.

In one aspect of the of the disclosure the operation on the vehicle includes changing a speed of the vehicle with a green light optimized speed advisory system on the vehicle.

In one aspect of the of the disclosure the type of controller for the traffic signal includes a fixed time traffic signal controller and the traffic signal information includes a minimum remaining time for the current signal phase that is equal to a maximum remaining time for the current signal phase and the remaining time interval is equal to one of the minimum remaining time or the maximum remaining time.

In one aspect of the disclosure the type of controller for the traffic signal includes a non-fixed time traffic signal controller.

In one aspect of the of the disclosure the traffic signal information includes the current signal phase for a given traffic lane corresponding to the vehicle and a current conflicting signal phase for a conflicting traffic lane.

In one aspect of the of the disclosure the traffic signal information includes a minimum remaining time for the current signal phase that is different from a maximum remaining time for the current signal phase and the traffic signal information includes a minimum remaining time for the current conflicting signal phase that is equal to a maximum remaining time for the current conflicting signal phase and the remaining time interval for the current signal phase is determined based on one of the minimum remaining time or the maximum remaining time for the current conflicting signal phase.

In one aspect of the disclosure determining the remaining time interval for the current signal phase includes determining if another vehicle is located between the vehicle and the traffic signal along a roadway and if the current signal phase includes an extendable time period.

Disclosed herein is a non-transitory computer-readable storage medium embodying programmed instructions which, when executed by a processor, are operable for performing a method. The method includes receiving traffic signal information from an infrastructure system for a traffic signal with the traffic signal information having a current signal phase of the traffic signal and determining a type of controller for the traffic signal based on the traffic signal information. The method also includes determining a remaining time interval for the current signal phase for the vehicle and directing an operation of the vehicle based on the remaining time interval for the current signal phase.

In one aspect of the disclosure the method includes determining a confidence level for the remaining time interval and directing the operation of the vehicle based on the remaining time interval and the confidence level.

In one aspect of the disclosure the operation of the vehicle includes starting or stopping an engine on the vehicle with a start/stop system for the vehicle.

In one aspect of the disclosure the operation includes utilizing a red light violation warning system on the vehicle to warn an operator of the vehicle of a risk of violating a red signal phase.

In one aspect of the disclosure the operation on the vehicle includes changing a speed of the vehicle with a green light optimized speed advisory system on the vehicle.

In one aspect of the disclosure the type of controller for the traffic signal includes a non-fixed time traffic signal controller and the traffic signal information includes the current signal phase for a given traffic lane corresponding to the vehicle and a current conflicting signal phase for a conflicting traffic lane.

In one aspect of the disclosure the traffic signal information includes a minimum remaining time for the current signal phase that is different from a maximum remaining time for the current signal phase and the traffic signal information includes a minimum remaining time for the current conflicting signal phase that is equal to a maximum remaining time for the current conflicting signal phase and the remaining time interval for the current signal phase is determined based on one of the minimum remaining time or the maximum remaining time for the current conflicting signal phase.

Disclosed herein is a vehicle. The vehicle includes a body at least partially defining a passenger cabin, a communication system configured to communicate with an infrastructure system, and a controller in electrical communication with the communication system. The controller configured to receive traffic signal information with the communication system from an infrastructure system for a traffic signal with the traffic signal information includes a current signal phase of the traffic signal and determine a type of controller for the traffic signal based on the traffic signal information. The controller is also configured to determine a remaining time interval for the current signal phase for the vehicle and direct an operation of the vehicle based on the remaining time interval for the current signal phase.

In one aspect of the disclosure the type of controller for the traffic signal includes a non-fixed time traffic signal controller and the traffic signal information includes the current signal phase for a given traffic lane corresponding to the vehicle and a current conflicting signal phase for a conflicting traffic lane.

In one aspect of the disclosure the traffic signal information includes a minimum remaining time for the current signal phase that is different from a maximum remaining time for the current signal phase and the traffic signal information includes a minimum remaining time for the current conflicting signal phase that is equal to a maximum remaining time for the current conflicting signal phase and the remaining time interval for the current signal phase is determined based on one of the minimum remaining time or the maximum remaining time for the current conflicting signal phase.

### BRIEF DESCRIPTION OF THE DRAWINGS

The accompanying drawings, which are incorporated into and constitute a part of this specification, illustrate implementations of the disclosure and together with the description, explain the principles of the disclosure.

FIG. 1 is a schematic illustration of an example vehicle.

FIG. 2 is a schematic illustration of the vehicle of FIG. 1 located adjacent to a connected intersection having at least one traffic signal.

FIG. 3 is a flow chart of an example method of operating the vehicle of FIG. 1 based on determining a remaining time interval for a current signal phase for a given direction of the traffic signal of FIG. 2.

FIG. 4 is a flow chart of an example predictive model for determining the remaining time interval for a traffic signal having a non-fixed time traffic signal controller.

FIG. 5 is a schematic illustration of a traffic signal phase diagram for a fixed time traffic signal controller.

FIG. 6 is a schematic illustration of a traffic signal phase diagram for a non-fixed time traffic signal controller.

FIG. 7 is a schematic illustration of a first traffic signal phase diagram in a given direction and a second traffic signal phase diagram in a conflicting direction.

FIG. 8 is a schematic illustration of another traffic signal phase diagram for a non-fixed time traffic signal controller.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may include a number of hardware, software, and/or firmware components configured to perform the specified functions.

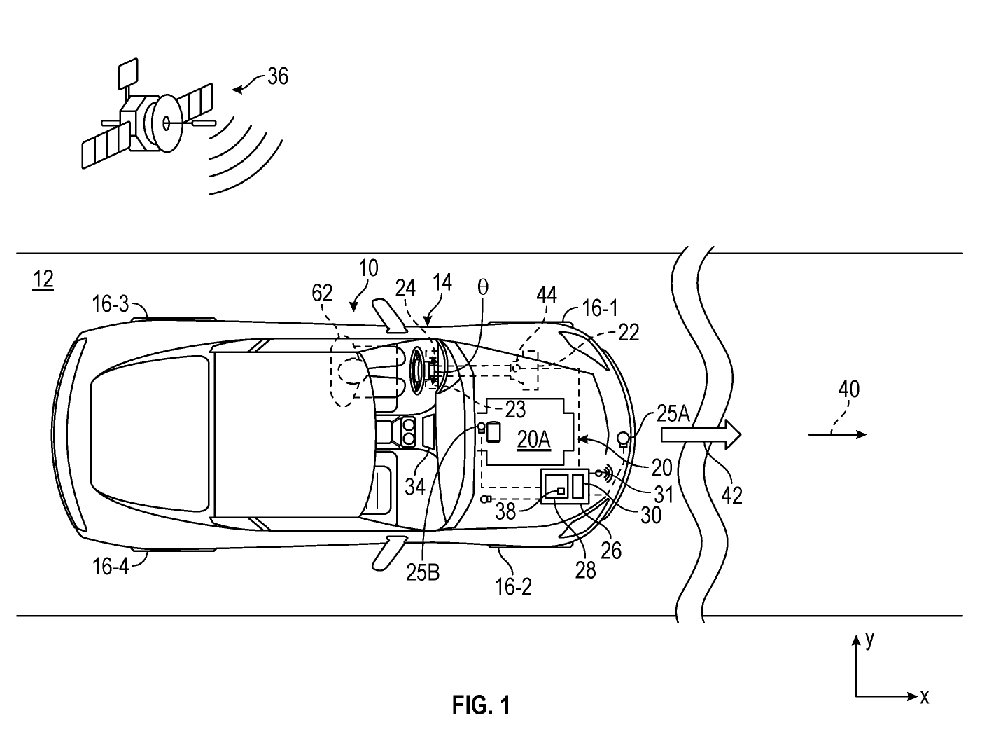

Referring to the FIGS., wherein like numerals indicate like parts referring to the drawings, wherein like reference numbers refer to like components, FIG. 1 shows a schematic view of a motor vehicle 10 positioned relative to a road surface 12, such as a vehicle lane. As shown in FIG. 1, the vehicle 10 includes a vehicle body 14, a first axle having a first set of road wheels 16-1, 16-2, and a second axle having a second set of road wheels 16-3, 16-4 (such as individual left-side and right-side wheels on each axle). Each of the road wheels 16-1, 16-2, 16-3, 16-4 employs tires configured to provide frictional contact with the road surface 12. Although two axles, with the respective road wheels 16-1, 16-2, 16-3, 16-4, are specifically shown, nothing precludes the motor vehicle 10 from having additional axles.

As shown in FIG. 1, a vehicle suspension system operatively connects the vehicle body 14 to the respective sets of road wheels 16-1, 16-2, 16-3, 16-4 for maintaining contact between the wheels and the road surface 12, and for maintaining handling of the motor vehicle 10. The motor vehicle 10 additionally includes a drivetrain 20 having a power-source or multiple power-sources 20A, which may be an internal combustion engine (ICE), an electric motor, or a combination of such devices, configured to transmit a drive torque to the road wheels 16-1, 16-2 and/or the road wheels 16-3, 16-4. The motor vehicle 10 also employs vehicle operating or control systems, including devices such as one or more steering actuators 22 (for example, an electrical power steering unit) configured to steer the road wheels 16-1, 16-2, a steering angle (θ), an accelerator device 23 for controlling power output of the power-source(s) 20A, a braking switch or device 24 for retarding rotation of the road wheels 16-1 and 16-2 (such as via individual friction brakes located at respective road wheels), etc.

As shown in FIG. 1, the motor vehicle 10 includes at least one sensor 25A and an electronic controller 26 that cooperate to at least partially control, guide, and maneuver the vehicle 10 in an autonomous mode during certain situations. As such, the vehicle 10 may be referred to as an autonomous vehicle. However, this disclosure also applies to semi-autonomous and manually driven motor vehicles. To enable efficient and reliable autonomous vehicle control, the electronic controller 26 may be in operative communication with the steering actuator(s) 22 configured as an electrical power steering unit, accelerator device 23, and braking device 24. The sensors 25A of the motor vehicle 10 are operable to sense the road surface 12 and monitor a surrounding geographical area and traffic conditions proximate to the motor vehicle 10.

The sensors 25A of the vehicle 10 may include, but are not limited to, at least one of a Light Detection and Ranging (LIDAR) sensor, radar, or camera (optical sensor) located around the vehicle 10 to detect the boundary indicators, such as edge conditions, of the road surface 12. The type of sensors 25A, their location on the vehicle 10, and their operation for detecting and/or sensing the boundary indicators of the road surface 12 and monitor the surrounding geographical area and traffic conditions are understood by those skilled in the art, are not pertinent to the teachings of this disclosure, and are therefore not described in detail herein. The vehicle 10 may additionally include sensors 25B, such as an inertial measurement unit (IMU), communication system, or other device, attached to the vehicle body and/or drivetrain 20.

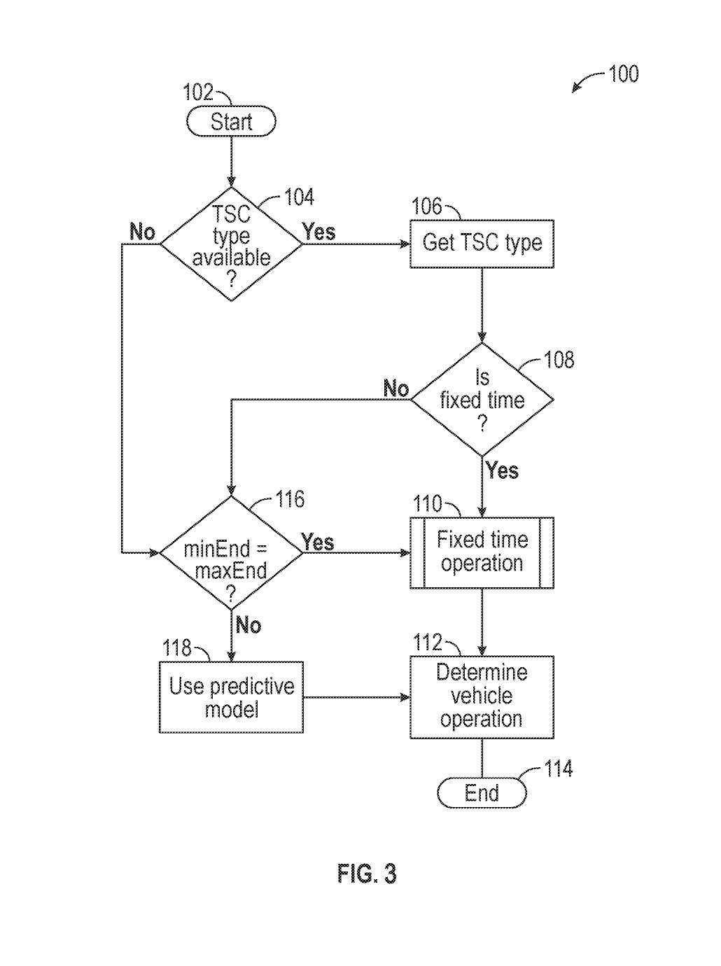

The electronic controller 26 is disposed in communication with the sensors 25A of the vehicle 10 for receiving their respective sensed data related to the detection or sensing of the road surface 12 and monitoring of the surrounding geographical area and traffic conditions. The electronic controller 26 may alternatively be referred to as a control module, a control unit, a controller, a vehicle controller, a computer, etc. The electronic controller 26 may include a computer and/or processor 28, and include software, hardware, memory, algorithms, connections (such as connections to sensors 25A and 25B), etc., for managing and controlling the operation of the vehicle 10. As such, a method, described below and generally represented in FIG. 3, may be embodied as a program or algorithm partially operable on the electronic controller 26. It should be appreciated that the electronic controller 26 may include a device capable of analyzing data from the sensors 25A and 25B, comparing data, making the decisions required to control the operation of the vehicle 10, and executing the required tasks to control the operation of the vehicle 10.

The electronic controller 26 may be embodied as one or multiple digital computers or host machines each having one or more processors 28, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and input/output (I/O) circuitry, I/O devices, and communication interfaces, as well as signal conditioning and buffer electronics. The computer-readable memory may include non-transitory/tangible medium which participates in providing data or computer-readable instructions. Memory may be non-volatile or volatile. Non-volatile media may include, for example, optical or magnetic disks and other persistent memory. Example volatile media may include dynamic random-access memory (DRAM), which may constitute a main memory. Other examples of embodiments for memory include a flexible disk, hard disk, magnetic tape or other magnetic medium, a CD-ROM, DVD, and/or other optical medium, as well as other possible memory devices such as flash memory.

The electronic controller 26 includes a tangible, non-transitory computer readable memory 30 on which computer-executable instructions, including one or more algorithms, are recorded for regulating operation of the motor vehicle 10. The subject algorithm(s) may specifically include an algorithm configured to determine a status of a traffic signal.

The motor vehicle 10 also includes a vehicle navigation system 34, which may be part of integrated vehicle controls, or an add-on apparatus used to find travel direction in the vehicle. The vehicle navigation system 34 is also operatively connected to a global positioning system (GPS) 36 using an earth orbiting satellite. The vehicle navigation system 34 in connection with the GPS 36 and the above-mentioned sensors 25A may be used for automation of the vehicle 10. The electronic controller 26 is in communication with the GPS 36 via the vehicle navigation system 34. The vehicle navigation system 34 uses a satellite navigation device (not shown) to receive its position data from the GPS 36, which is then correlated to the vehicle’s position relative to the surrounding geographical area. Based on such information, when directions to a specific waypoint are needed, routing to such a destination may be mapped and calculated. On-the-fly terrain and/or traffic information may be used to adjust the route. The current position of a vehicle 10 may be calculated via dead reckoning – by using a previously determined position and advancing that position based upon given or estimated speeds over elapsed time and course by way of discrete control points.

The electronic controller 26 is generally configured, i.e., programmed, to determine or identify localization 38 (current position in the X-Y plane, shown in FIG. 1), velocity, acceleration, yaw rate, as well as an intended path 40, and heading 42 of the motor vehicle 10 on the road surface 12. The localization 38, intended path 40, and heading 42 of the motor vehicle 10 may be determined via the navigation system 34 receiving data from the GPS 36, while velocity, acceleration (including longitudinal and lateral g’s), and yaw rate may be determined from vehicle sensors 25B. Alternatively, the electronic controller 26 may use other systems or detection sources arranged remotely with respect to the vehicle 10, for example a camera, to determine localization 38 of the vehicle relative to the road surface 12.

As noted above, the motor vehicle 10 may be configured to operate in an autonomous mode guided by the electronic controller 26 to transport an occupant or driver 62. In such a mode, the electronic controller 26 may further obtain data from vehicle sensors 25B to guide the vehicle along the desired path, such as via regulating the steering actuator 22. The electronic controller 26 may be additionally programmed to detect and monitor the steering angle (θ) of the steering actuator(s) 22 along the desired path 40, such as during a negotiated turn. Specifically, the electronic controller 26 may be programmed to determine the steering angle (θ) via receiving and processing data signals from a steering position sensor 44 (shown in FIG. 1) in communication with the steering actuator(s) 22, accelerator device 23, and braking device 24.

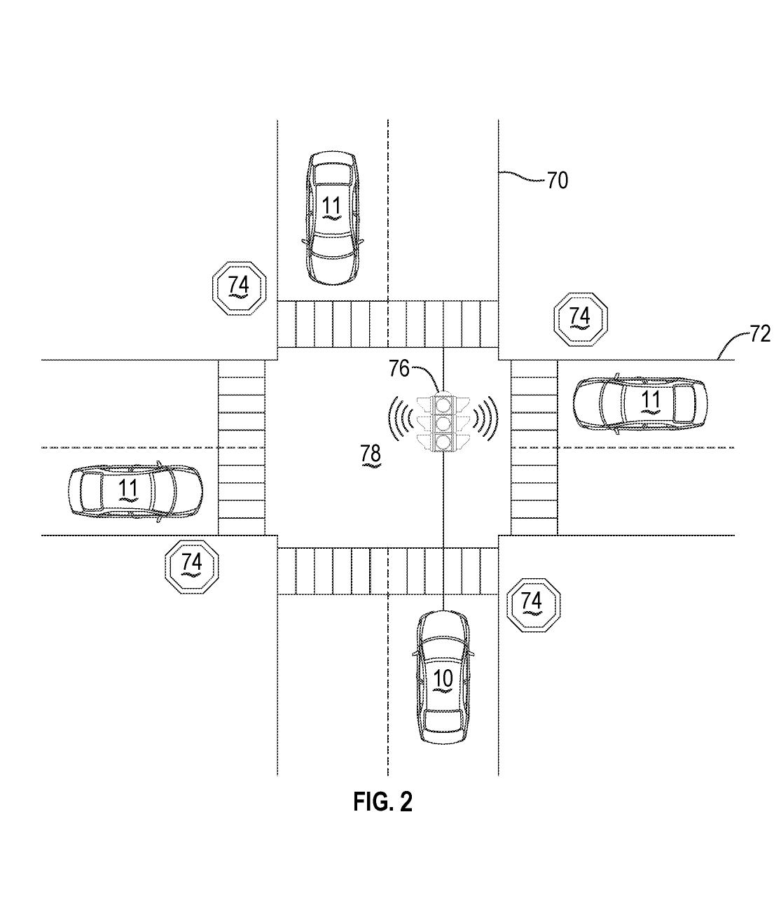

With reference to FIG. 2, the vehicle 10 may be operated along a first roadway 70 that intersects a second roadway 72 to form an intersection 78. In the illustrated example, a traffic signal 76 controls the flow of traffic through the intersection 78. Other vehicles 11 may be located at the intersection 78 with a parallel or a conflicting direction of travel. The other vehicles 11 may be vehicles as described above with respect to the vehicle 10. Alternatively, the other vehicles 11 may not include the additional sensors 25A and 25B with the associated control system and ability to communicate with a connected intersection having the traffic signal 76 forming a portion of the infrastructure system 74. For example, the vehicle 10 utilizes a communication system 31 to communicate with the infrastructure system 74.

In one example, the vehicle 10 communicates with the infrastructure system 74, such as the traffic signal 76 or other sensors, through a wireless communication system (e.g. vehicle to infrastructure (V2I), vehicle to everything (V2X), or cellular vehicle to everything (C-V2X)). The traffic signal 76 is configured to broadcast a signal indicative of the state of the light phases and a remaining duration for the current signal phase. In this disclosure, the traffic signal 76 can include a fixed time traffic signal controller (“TSC”) or a non-fixed time TSC. The fixed time TSC includes a central processing unit configured to execute algorithms stored in non-volatile memory to operate in distinct operational modes. Each mode comprises a predetermined cycle length subdivided into discrete phases as determined by the algorithms. For each intersection approach (e.g., north, south, east, west), the fixed time TSC allocates specific time intervals for permissive movements (green phase), warning intervals (yellow phase), and restrictive intervals (red phase).

Multiple timing plans may be stored simultaneously for the fixed time TSC and activated according to predetermined schedules (e.g., morning peak, off-peak, evening peak). Plan switching occurs at defined boundary points to prevent unsafe signal transitions. The fixed time TSC, unlike non-fixed time TSC, execute timing sequences irrespective of vehicle presence or absence at the intersection 78, thereby providing consistent and predictable operation, which may be advantageous for coordinated signal systems along arterial corridors.

The non-fixed time TSC includes a central processing unit configured to execute algorithms stored in non-volatile memory to operate in distinct operational modes. The non-fixed time TSC is also in communication with intersection sensors that form a portion of the infrastructure system 74 that provide real-time data to the non-fixed time TSC. In one example, the algorithms include minimum and maximum time intervals for each signal phase, extension parameters for selecting a time between the minimum (minEnd) and maximum time intervals (maxEnd), and transition states (e.g., yellow clearance intervals) in a semi-deterministic pattern. The intersection sensors can include inductive loops in the road surface, camera, radar, lidar, etc. for determining the presence of a vehicle at the intersection 78.

The non-fixed TSC operates in distinct operational modes with each mode capable of having a variable cycle length subdivided into discrete phases. For each intersection approach (e.g., north, south, east, west), the non-fixed TSC allocates dynamic time intervals for permissive movements (green indication) based on a number of factors. One factor may include a minimum green time parameter that ensures sufficient service for each approach, another may include unit extension parameters defining the incremental time added per detection, or maximum green time parameters establishing upper bounds for phase durations. Additionally, the dynamic time intervals may be based on gap detection algorithms that terminate green phases upon detection of adequate headway between vehicles.

The adaptive nature of the non-fixed time TSC allows the traffic signal 76 to redistribute unused green time from approaches with minimal demand to those experiencing heavier traffic volumes, thereby optimizing intersection efficiency and reducing unnecessary delay. The non-fixed time TSC may operate in fully actuated mode (all phases responsive to detection) or semi-actuated mode (main street phases operating on fixed timing while side street phases respond to detection).

FIG. 3 illustrates a flow chart of an example method 100 of operating the vehicle 10 based on determining a remaining time interval for a current signal phase for the traffic signal 76 as the vehicle 10 approaches the intersection 78. One feature of this disclosure is the ability to predict the remaining time interval for traffic signal 76 operating with either the fixed time TSC and the non-fixed time TSC. The method 100 begins at block 102 (“Start”) with the vehicle 10 approaching the intersection 78. The method 100 then proceeds to block 104.

At block 104 (“TSC type available?”), the method 100 determines if the TSC type for the traffic signal 76 at the intersection 78 is a fixed time TSC or a non-fixed time TSC. As discussed above, the infrastructure system 74 located adjacent to the intersection 78 is capable of transmitting traffic signal information regarding the traffic signal 76 and its operation. The traffic signal information may be communicated through V2I, V2X, or C-V2X communications that includes the exchange of dedicated short range communication (DSRC) messages or C-V2X messages with infrastructure system 74 and traffic signal 76 at the intersection 78 as shown in FIG. 2. The V2X messages, such as SPaT or Map, may convey specifications of the traffic signal 76, such as the timing pattern for operation of the lights or SPaT, controller type, or local intersection data that indicates which lane(s) along the roadways correspond with each of the signal phases of the traffic signal 76. If the method 100 determines that the TSC type is not provided in the V2X messages, the method 100 proceeds to block 116. Alternatively, if the method 100 determines that the TSC type is available from the V2X messages, the method 100 proceeds to block 106 (“Get TSC type”) to begin evaluating the TSC type at block 108 (“Fixed-time TSC”). If the TSC type is a fixed-time TSC, the method 100 proceeds to block 110.

At block 110 (“Fixed time operation”), the method 100 determines a cycle time for the current signal phase of the traffic signal 76. The cycle time includes a remaining time interval for the current signal phase before it changes to the next signal phase. The method 100 then proceeds to block 112.

At block 112 (“Control vehicle operation”), the method 100 utilizes the remaining time interval for the current signal phase of the traffic signal 76 to control an operation of the vehicle 10. Furthermore, as discussed in greater detail below, the method 100 may control operation of the vehicle 10 based on a confidence level in the remaining time interval when the TSC is a non-fixed time TSC.

In one example, the remaining time interval is utilized by the controller 26 to operate an engine start/stop system on the vehicle 10. This operation can include extending a period of time for the vehicle 10 to remain in a start configuration based on the remaining time interval. Alternatively, the method 100 utilizes the remaining time interval with the controller to reduce a remaining time period that the start/stop system has the vehicle 10 in a stop configuration. One feature of operating the vehicle 10 in this manner is to optimize the running time of the engine on the vehicle 10 based on the remaining time interval.

In another example, the method 100 utilizes a red light violation warning (RLVW) system on the vehicle 10. The RLVW system alerts a driver of the vehicle 10 or the autonomous system on the vehicle 10 to a change in phase for the traffic signal 76 based on the current signal phase and the remaining time interval. For example, if the current signal phase at the intersection 78 for the vehicle 10 includes a green phase and the remaining time interval indicates when a transition to a red phase will occur, the RLVW system provides a warning to the operator, such as through the navigation system 34 on the dash of the vehicle or through an audible warning, of a probability that the signal phase for the vehicle 10 will be red when the vehicle 10 reaches the intersection 78. In making this determination, the RLVW system determine the probability of the change based on a current speed of the vehicle 10 and a distance of the vehicle 10 from the intersection 78.

In yet another example, the method 100 utilizes a green light optimized speed advisory (GLOSA) system on the vehicle 10 to control a speed of the vehicle 10 along the roadway to allow the vehicle 10 to pass through the intersection 78 without coming to a complete stop. One feature of the GLOSA system is improved fuel economy and comfort for the occupants of the vehicle 10.

In further example, the method 100 can provide the remaining time interval of the current signal phase to the driver of the vehicle 10. This allows the driver of the vehicle 10 to be aware that an action to start or stop movement of the vehicle 10 may occur at the remaining time interval for the current signal phase. This information can be conveyed to the driver on a display associated with the navigation system 34 to allow the driver to manually decide how to proceed through the intersection 78.

After the method controls the operation of the vehicle 10 at block 112, the method 100 proceeds to block 114 (“End”) and ends until the vehicle 10 approaches another intersection 78.

If the method 100 determines at block 108 that the TSC type is not a fixed-time TSC or the controller type is not provided in the V2X messages, the method 100 proceeds to block 116. At block 116 (“minEnd = maxEnd?”), the method 100 determines if a minimum remaining time (“minEnd”) for the current signal phase is equal to a maximum remaining time (“maxEnd”) for the current signal phase based on the V2X messages. If minEnd is equal to maxEnd for the current signal phase, the method 100 proceeds to block 110. However, the method 100 can proceed to block 110 if the TSC is a fixed time TSC or a non-fixed time TSC because the non-fixed time TSC with minEnd equal to maxEnd behaves in the same manner as the fixed time TSC. Conversely, if the minEnd is not equal to the maxEnd for the current signal phase, the type of the TSC is confirmed to be a non-fixed time TSC and the method 100 proceeds to block 118.

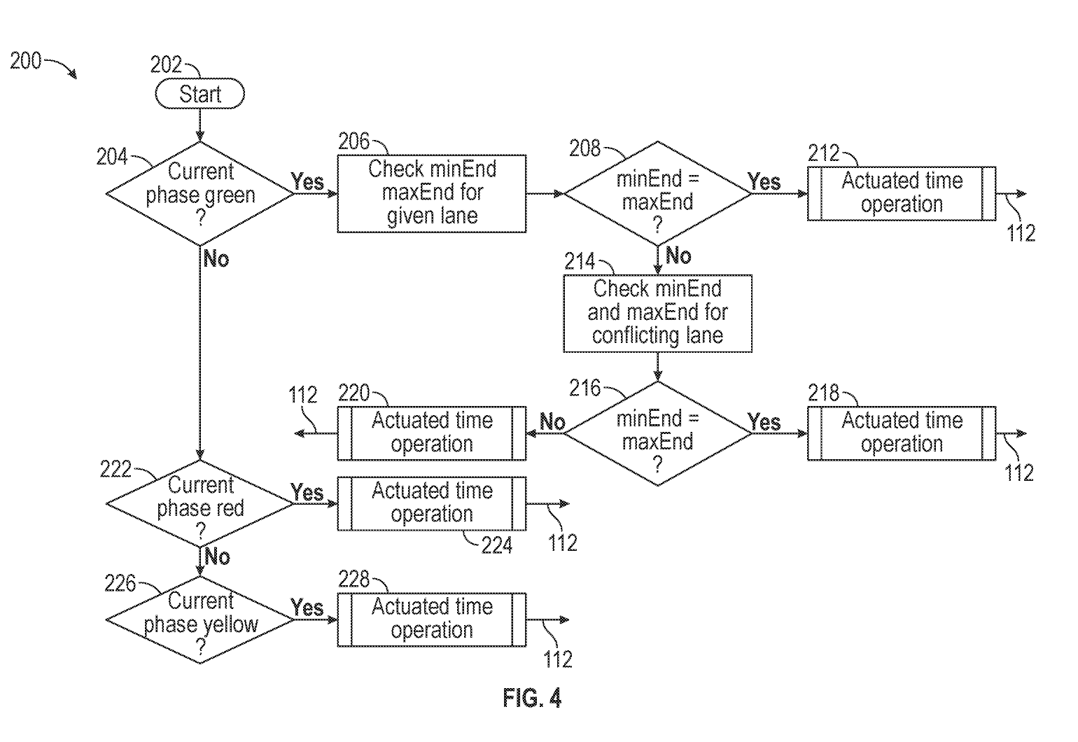

At block 118 (“Use Predicative Model”), the method 100 utilizes a predictive model 200 (FIG. 4) to predict the remaining time interval for the current signal phase with the non-fixed time TSC type. Additionally, the predictive model 200 can assign a confidence level to the prediction of the remaining time interval for the current signal phase. A flow chart illustrates the example predictive model 200 utilized by the method 100 at block 118 is shown in FIG. 4. The predictive model 200 begins at block 202 (“Start”) and then proceeds to block 204.

At block 204 (“Current phase green?”), the predictive model 200 determines if the current signal phase of the traffic signal 76 for the given vehicle 10 includes a green phase. If the current signal phase includes a green phase, the predictive model 200 proceeds to block 206.

At block 206 (“Check minEnd and maxEnd for given lane”), the predictive model 200 determines the minEnd and the maxEnd for the given lane along the first roadway 70 for the vehicle 10 approaching the intersection 78. The predictive model 200 can receive the minEnd and the maxEnd for the current signal phase from the V2X messages for one or more of the lanes at the intersection 78. In one example, the given lane for the vehicle 10 can be determined by the navigation system 34 on the vehicle 10 or the intersection sensors, including cameras or indicative sensors in the roadways forming a portion of the infrastructure system 74. With the minEnd and the maxEnd determined for the current signal phase and the given lane for the vehicle 10, the predictive model 200 proceeds to block 208.

At block 208 (“minEnd = maxEnd?”), the predictive model 200 determines if the minEnd and the maxEnd for the current signal phase are equal to each other such that they will occur at the same time or has the same duration. If minEnd is equal to maxEnd, the predictive model 200 proceeds to block 212.

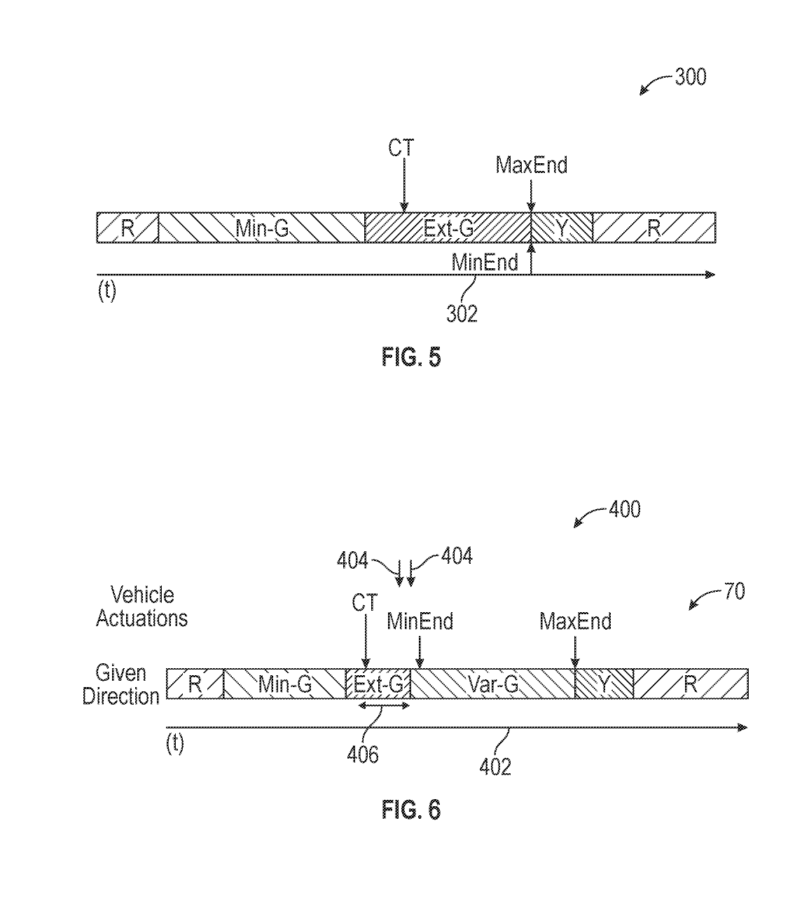

At block 212 (“Actuated time operation”), the predictive model 200 determines a time for an actuated operation when the traffic signal 76 changes from its current signal phase to the next signal phase based on the minEnd and maxEnd for the given lane of the vehicle 10. FIG. 5 illustrates an example traffic signal phase diagram 300 illustrating the various durations for each signal phase of the traffic signal 76. For the traffic signal phase diagram 300 shown in FIG. 5, the traffic signal phases are shown occurring over a timeline (t) 302 that begins with a red phase R, then transitions to a minimum green phase Min-G, an extended green phase Ext-G, a yellow phase Y, and then returns to the red R phase to begin the cycle again. As shown in the illustrated example of FIG. 5, for a current time CT within the Ext G phase, minEnd and maxEnd are equal such that they both occur at the same time along the timeline (t) 302. In this situation, the non-fixed time TSC is treated like the fixed time TSC because minEnd and maxEnd are equal such that the time of the transition to the yellow phase Y is given. In this situation, the remaining time interval for the current signal phase is determined by subtracting the current time CT from the time associated with either the maxEnd or the minEnd.

The predictive model 200 can also determine a confidence rating for the remaining time interval for the current signal phase. In this situation, the confidence rating is determined to be at a maximum or very high level, because the minEnd and the maxEnd are equal such that the remaining time interval for the current signal phase is given with certainty.

If minEnd is determined not to be equal to maxEnd at block 208, the predictive model 200 proceeds to block 214. At block 214 (“Check minEnd and maxEnd for conflicting lane), the predictive model 200 obtains the minEnd and maxEnd for at least one conflicting lane of traffic at the intersection 78. In one example, the conflicting lane includes a direction of travel for another vehicle 11 that would intersect the given direction of travel for the vehicle 10 such that the two vehicles are unable to travel along each path at the same time. With the minEnd and maxEnd for the conflicting lane, the predictive model 200 proceeds to block 216.

At block 216 (“minEnd = maxEnd?”), the predictive model 200 determines if the minEnd for the current signal phase in the conflicting lane is equal to maxEnd. If minEnd is not equal to maxEnd for the conflicting lane, the predictive model 200 proceeds to block 220.

At block 220 (“Actuated time operation”), the predictive model 200 determines a time for an actuated operation when the traffic signal 76 changes from its current signal phase to the next phase based on the minEnd and maxEnd for the conflicting lane. FIG. 6 illustrates an example traffic signal phase diagram 400 illustrating the various durations for each phase of the traffic signal 76. For the traffic signal phase diagram 400 shown in FIG. 6, the traffic signal phases are shown occurring over a time period (t) 402 that begins with a red phase R, then transitions to a minimum green phase Min-G, an extended green phase Ext-G, a variable green duration phase Var-G, a yellow Y phase, and then returns back to the red phase R to begin the cycle again. As shown in the illustrated example of FIG. 6, for the given current time CT in extended green phase Ext-G, there is an assured green duration 406 that is determined by subtracting the current time CT from the time (t) associated with the minEnd for the extended green phase Ext-G.

In this example, the variable green phase Var-G creates a window of possible signal phase that could occur between minEnd and maxEnd. Furthermore, in this example, the predictive model 200 identified additional vehicles 404 represented by arrows located along the first roadway 70 between the vehicle 10 and the traffic signal 76 at the intersection 78.

The vehicles 404 can be identified by sensors 25A or 25B on the vehicle 10 or with the infrastructure system 74 at the intersection 78. Because of the location of these vehicles 404 between the vehicle 10 and the intersection 78 in connection with the availability of additional time due to the current signal phase being the variable green phase Var-G, the predictive model 200 can predict that the current signal phase for the traffic signal 76 will be further extended beyond minEnd. In one example, the predictive model 200 determines a likelihood of the extension based on a distance of the vehicle 10 to the intersection 78. If this distance is greater than a predetermined threshold distance, the predictive model 200 will determine a low likelihood that the green signal phase will be further extended. However, if the distance is less than the predetermined threshold distance, the predictive model 200 can predict a mid or high likelihood that the current green signal phase will be extended further into the variable green phase Var-G. Furthermore, the predictive model 200 can determine if the vehicle 10 will pass through the intersection 78 based on its current speed and distance from the intersection 78 based on the available time with the variable green phase Var-G in making its confidence estimate.

If the vehicle 10 is within a RLVW warning region for the RLVW system and there are additional vehicles 404 between it and the intersection 78, the predictive model 200 can predict that there is a very high likelihood that the variable green phase Var-G will be extended further. If the distance to the intersection 78 for the vehicle 10 is less than the predetermined distance above but greater than a distance defining the RLVW warning region from the intersection 78, the predictive model 200 can assign a medium to high likelihood that the current signal phase will be extended into the variable green phase Var-G. The predictive model 200 can then proceed to block 112 of the method 100 and utilize the remaining time interval with its associated confidence level when determining an appropriate operation for the vehicle 10.

If the predictive model 200 determines that minEnd are equal at block 216, the predictive model 200 will proceed to block 218. At block 218 (“Actuator time operation”), the predictive model 200 determines a time for an actuated operation when the traffic signal 76 changes from its current signal phase to the next phase based on the minEnd and maxEnd for the conflicting lane of traffic.

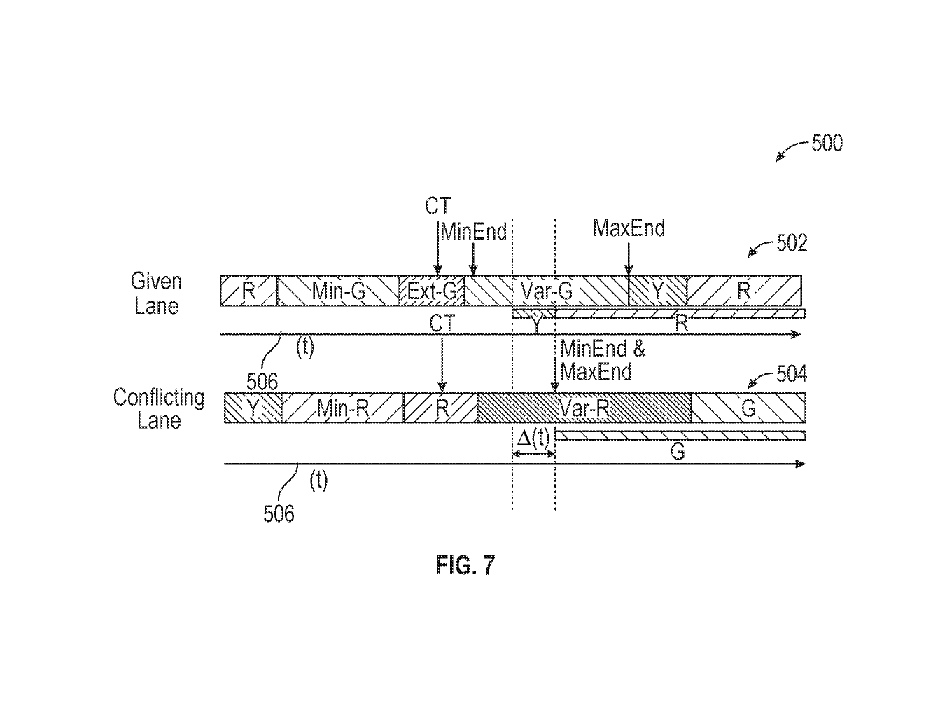

FIG. 7 illustrates an example traffic signal phase diagram 500 illustrating the various durations for each phase of the traffic signal 76 for the given lane 502 and the conflicting lane 504 over a time (t) 506. For the given lane 502, the traffic signal phase diagram is shown cycling through a red phase R, a minimum green phase Min-G, an extended green phase Ext-G., a variable green phase Var-G, a yellow phase Y, and then returning back to the red phase R. For the conflicting lane 504, the signal phase diagram is shown cycling through complementary phases beginning with the yellow phase Y, a minimum red phase Min-R, an extended red phase Ext-R, a variable red phase Var-R, and then to a green phase before returning back to the yellow phase Y.

As shown in FIG. 7, at a current time (CT), there is an assured green duration for the given lane 502. The assured green duration is determined by subtracting the current time CT from the time (t) associated with the minEnd for the extended green light (Ext. G). However, the variable green phase Var-G could possibly extend to maxEnd for the given lane 502 based on the traffic signal phase diagram 500. To predict when the green phase G for the given lane 502 will end or transition to yellow, the predictive model 200 investigates the phase diagram for the conflicting lane 504.

In the illustrated example, the traffic signal phase diagram 500 in the conflicting lane 504 shows minEnd and maxEnd for the current signal phase (e.g., the variable red phase Var-R) are equal to each other as they occur at the same time (t). This indicates a point in time (t) in the traffic signal phase diagram 500 where the variable red phase Var-R for the conflicting lane 504 will switch or transition to the green phase G. With this information from the traffic signal phase diagram 500, the predictive model 200 can determine when the variable green phase Var-G will end on the traffic signal phase diagram 500 for the given lane 502. The predictive model 200 can then apply a predetermined phase length (Δt) corresponding to the yellow phase Y for the given lane 502 to determine when the green signal phase for the given lane 502 would transition to the yellow phase Y. The predictive model 200 then proceeds to block 112 of FIG. 3 to determine the vehicle operation for the vehicle 10.

If the predictive model 200 determines at block 204 that the current signal phase is not green, the predictive model 200 proceeds to block 222. At block 222 (“Current phase red?”), the predictive model 200 determines if the current signal phase for the traffic signal 76 for the vehicle 10 is red. If the current signal phase is red, the predictive model 200 proceeds to block 224.

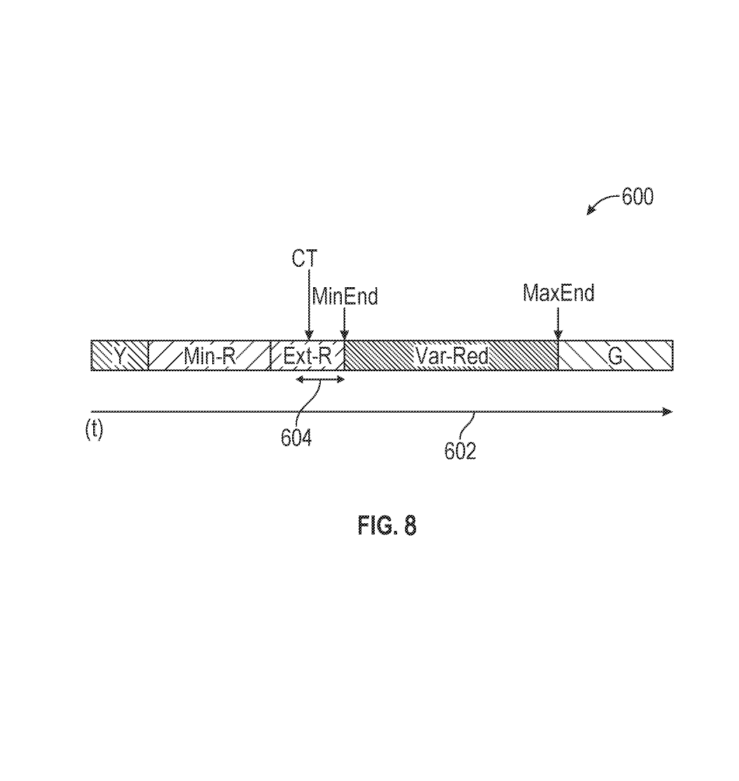

At block 224 (“Actuated time operation”), the predictive model 200 determines a time for an actuated operation when the traffic signal 76 changes from its current signal phase to the next phase based on the minEnd and maxEnd for the lane corresponding to the vehicle 10. FIG. 8 illustrates an example traffic signal phase diagram 600 illustrating the various durations for each phase of the traffic signal 76. For the traffic signal phase diagram 600 shown in FIG. 8, the traffic signal phases are shown occurring over a timeline (t) 602 that begins with a yellow phase (Y), then transitions to a minimum red phase Min-R, an extended red phase Ext-R, a variable red phase Var-R, and a green phase G. As shown in the illustrated example of FIG. 8, at the given current time CT, there is an assured red duration 604 that is determined by subtracting the current time CT from the time associated with the minEnd for the extended red phase Ext-R.

In this example, the variable red phase Var-R extends along the timeline 602 from a time corresponding to minEnd to a time corresponding to maxEnd. AT a time between minEnd and maxEnd, it is possible that the variable red phase Var-R could transition to the next phase. Due to the possibility that the variable red phase Var-R could change between minEnd and maxEnd, the predictive model 200 could assign the remaining time interval for the current signal phase to be equal to the assured red duration 604 and assign a low confidence level to this determination as there are not additional pieces of information regarding activities at the intersection 78 that could determine a more accurate remaining time interval for the current signal phase. The predictive model 200 then proceeds to block 112 of FIG. 3 to determine the vehicle operation for the vehicle 10.

If the current phase is not red at block 222, the predictive model 200 proceeds to block 226. At block 226 (“Current phase yellow?”), the predictive model 200 determines if the current signal phase is yellow Y. If the predictive model determines that the current phase is yellow, the predictive model 200 proceeds to block 228.

At block 228 (“Actuated time operation”), the predictive model 200 determines a remaining time for the yellow phase. As the yellow phase has a fixed time period, a minEnd and maxEnd will be equal for the yellow phase. Therefore, the remaining time interval can be determined by subtracting the current time from the time associated with either the minEnd or the maxEnd. The predictive model 200 then proceeds to block 112 of FIG. 3 to determine the vehicle operation for the vehicle 10 as discussed above.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure is not limited to the particular embodiments disclosed but will include embodiments falling within the scope thereof.

What is claimed is:

1. A method of operating a vehicle, the method comprising:
receiving traffic signal information from an infrastructure system for a traffic signal, wherein the traffic signal information includes a current signal phase of the traffic signal;
determining a type of controller for the traffic signal based on the traffic signal information;
determining a remaining time interval for the current signal phase for the vehicle; and
directing an operation of the vehicle based on the remaining time interval for the current signal phase.

2. The method of claim 1, including determining a confidence level for the remaining time interval and directing the operation of the vehicle based on the remaining time interval and the confidence level.

3. The method of claim 1, wherein the operation of the vehicle includes starting or stopping an engine on the vehicle with a start/stop system on the vehicle.

4. The method of claim 1, wherein the operation includes utilizing a red light violation warning system on the vehicle to warn an operator of the vehicle of a red signal phase.

5. The method of claim 1, wherein the operation on the vehicle includes changing a speed of the vehicle with a green light optimized speed advisory system on the vehicle.

6. The method of claim 1, wherein the type of controller for the traffic signal includes a fixed time traffic signal controller and the traffic signal information includes a minimum remaining time for the current signal phase that is equal to a maximum remaining time for the current signal phase and the remaining time interval is equal to one of the minimum remaining time or the maximum remaining time.

7. The method of claim 1, wherein the type of controller for the traffic signal includes a non-fixed time traffic signal controller.

8. The method of claim 7, wherein the traffic signal information includes the current signal phase for a given traffic lane corresponding to the vehicle and a current conflicting signal phase for a conflicting traffic lane.

9. The method of claim 8, wherein the traffic signal information includes a minimum remaining time for the current signal phase that is different from a maximum remaining time for the current signal phase and the traffic signal information includes a minimum remaining time for the current conflicting signal phase that is equal to a maximum remaining time for the current conflicting signal phase and the remaining time interval for the current signal phase is determined based on one of the minimum remaining time or the maximum remaining time for the current conflicting signal phase.

10. The method of claim 9, wherein determining the remaining time interval for the current signal phase includes determining if another vehicle is located between the vehicle and the traffic signal along a roadway and if the current signal phase includes an extendable time period.

11. A non-transitory computer-readable storage medium embodying programmed instructions which, when executed by a processor, are operable for performing a method comprising:
receiving traffic signal information on a vehicle from an infrastructure system for a traffic signal, wherein the traffic signal information includes a current signal phase of the traffic signal;
determining a type of controller for the traffic signal based on the traffic signal information;
determining a remaining time interval for the current signal phase for the vehicle; and
directing an operation of the vehicle based on the remaining time interval for the current signal phase.

12. The non-transitory computer-readable storage medium of claim 11, wherein the method includes determining a confidence level for the remaining time interval and directing the operation of the vehicle based on the remaining time interval and the confidence level.

13. The non-transitory computer-readable storage medium of claim 11, wherein the operation of the vehicle includes starting or stopping an engine on the vehicle with a start/stop system for the vehicle.

14. The non-transitory computer-readable storage medium of claim 11, wherein the operation includes utilizing a red light violation warning system on the vehicle to warn an operator of the vehicle of a risk of violating a red signal phase.

15. The non-transitory computer-readable storage medium of claim 11, wherein the operation on the vehicle includes changing a speed of the vehicle with a green light optimized speed advisory system on the vehicle.

16. The non-transitory computer-readable storage medium of claim 11, wherein the type of controller for the traffic signal includes a non-fixed time traffic signal controller and the traffic signal information includes the current signal phase for a given traffic lane corresponding to the vehicle and a current conflicting signal phase for a conflicting traffic lane.

17. The non-transitory computer-readable storage medium of claim 16, wherein the traffic signal information includes a minimum remaining time for the current signal phase that is different from a maximum remaining time for the current signal phase and the traffic signal information includes a minimum remaining time for the current conflicting signal phase that is equal to a maximum remaining time for the current conflicting signal phase and the remaining time interval for the current signal phase is determined based on one of the minimum remaining time or the maximum remaining time for the current conflicting signal phase.

18. A vehicle, comprising:
a body at least partially defining a passenger cabin;
a communication system configured to communicate with an infrastructure system; and
a controller in electrical communication with the communication system, the controller configured to:
receive traffic signal information with the communication system from an infrastructure system for a traffic signal, wherein the traffic signal information includes a current signal phase of the traffic signal;
determine a type of controller for the traffic signal based on the traffic signal information;
determine a remaining time interval for the current signal phase for the vehicle;
direct an operation of the vehicle based on the remaining time interval for the current signal phase; and
determine a confidence level for the remaining time interval and directing the operation of the vehicle based on the remaining time interval and the confidence level.

19. The vehicle of claim 18, wherein the type of controller for the traffic signal includes a non-fixed time traffic signal controller and the traffic signal information includes the current signal phase for a given traffic lane corresponding to the vehicle and a current conflicting signal phase for a conflicting traffic lane.

20. The vehicle of claim 19, wherein the traffic signal information includes a minimum remaining time for the current signal phase that is different from a maximum remaining time for the current signal phase and the traffic signal information includes a minimum remaining time for the current conflicting signal phase that is equal to a maximum remaining time for the current conflicting signal phase and the remaining time interval for the current signal phase is determined based on one of the minimum remaining time or the maximum remaining time for the current conflicting signal phase.
